(19) United States
(12) Patent Application Publication
(10) Pub. No.: US 2019/0252706 A1
(43) Pub. Date: Aug. 15, 2019

(54) CERAMIC ION-SELECTIVE MEMBRANE ASSEMBLY

(71) Applicant: UNIVERSITETET I OSLO, Oslo (NO)

(72) Inventors: Truls Eivind NORBY, Gjerdrum (NO); Yngve LARRING, Langhus (NO); Ragnhild HANCKE, Oslo (NO); Zuoan LI, Oslo (NO); Wen XING, Oslo (NO); Marie-Laure FONTAINE, Oslo (NO); Tor GRANDE, Trondheim (NO); Mtabazi Geofrey SAHINI, Trondheim (NO)

(73) Assignee: UNIVERSITETET I OSLO, Oslo (NO)

(21) Appl. No.: 16/086,124

(22) PCT Filed: Mar. 15, 2017
(86) PCT No.: PCT/NO2017/050066

§ 371 Date: Sep. 18, 2018

(30) Foreign Application Priority Data
Mar. 18, 2016 (NO) 20160469

(51) Int. Cl. H01M 8/1246; H01M 8/1039; B01D 71/02; B01D 69/02; H01M 8/1044

(52) U.S. Cl. CPC H01M 8/1246; H01M 8/1039; H01M 2300/0074; B01D 69/02; H01M 8/1044; B01D 71/024

(57) ABSTRACT

A self-healing ceramic ion-selective membrane assembly including a ceramic ion-selective membrane, and at least one additive layer. The at least one additive layer includes an ionic ceramic material which is porous or ion-selective. The at least one additive layer having a metal cation diffusivity higher than the metal cation diffusivity of the ceramic ion-selective membrane. When a defect occurs through the ceramic ion-selective membrane, metal cation transport will be enhanced by orders of magnitude towards and into the defect, driven by the chemical or electrical potential difference between the two sides of the membrane.

The present invention relates to a self-healing ceramic ion-selective membrane assembly, and to a method of establishing a self-generating, self-healing ion-selective membrane assembly, and the use of the self-healing ceramic ion-selective membrane assembly.

Ceramic ion-selective membranes exhibit fast transport in terms of high conductivity of ions, such as oxide ions or protons, making them useful as electrolytes in fuel cells, electrolysers, electrochemical pumps, and sensors. They can also exhibit additional conductivity of electrons, and in this case, the combined ionic/electronic conductivity makes the membrane permeable to the gas corresponding to the mobile ion, and it may be used as a gas separation membrane for e.g. oxygen or hydrogen.

Generally, ceramic ion-selective membranes contain a dense functional layer made of an inorganic non-metallic material. These may be metal oxides, nitrides, carbides, phosphates and sulphates. In all cases, the fast transport of ions, such as oxide ions or protons, must be accompanied by a negligible or comparatively very slow transport of metal cations in terms of a low partial conductivity of metal cations of the membrane material, ensuring that the framework structure of the membrane stays stationary when exposed to chemical or electrical gradients.

These membranes need to be thin (typically of the order of about 10 μm to 50 μm) to minimize the resistance to transport of the fast ions. However, over time these thin ceramic membranes are prone to forming defects, for example due to cracking under mechanical stresses arising from operation, handling, or thermal cycling. Additionally, if the ceramic membrane is contaminated during manufacture, for example by dust particles or other inhomogeneities, this can result in severe defects in the ceramic membrane, such as cracks and holes through the ion-selective membrane. These defects may reduce the production acceptance rate, the effectiveness during operation, and the lifetime of the ion-selective membrane.

For example, when ceramic ion-selective membranes are used in fuel cells, it is common that over time, a number of defects form in the material. This can result in leakage through the membrane with unwanted direct reaction between fuel and oxidant, reducing the fuel-to-electricity efficiency. When the amount of leaking reaches a certain level, it is necessary to shut off or replace the ion-selective membranes because of safety or as the efficiency of the device is reduced too much. Membranes can usually not be replaced individually or as single cells, but instead entire stacks or modules need to be shut down and replaced. This results in downtime, which reduces the overall output of the fuel cell installation and reliability of the power supply. Similar considerations apply for other electrochemical devices based on ion-selective ceramic membranes, such as electrolysers, pumps, and reactors, or gas separation membranes.

In order to reduce the risk of defects through the membrane, the ceramic ion-selective membranes will often have to be made thicker than necessary. However, a higher thickness reduces ion transport rate through the membrane and makes the membrane less efficient. Other disadvantages are increased materials cost, weight, and footprint of the installation.

Additionally, the membranes are made in costly clean-rooms to reduce the chance of contamination and resulting defects. Even with clean-rooms, a relatively large percentage of membranes made need to be discarded due to flaws.

It is therefore a desire to provide a ceramic ion-selective membrane, which is less prone to having defects such as holes and cracks.

US 2006/0234097 discloses a self-healing polymer membrane for a fuel cell. The self-healing membrane comprises a porous, non-ion-conductive material and one polymer ion-conductive electrolyte, which fills the pores of the non-ion-conducting material. The non-ion-conducting material has lower melting point than the ion-conducting electrolyte. When there is a leak (e.g. a hole or a crack) in the membrane during use, the porous non-ion-conducting material melts as result of a temperature rise, which occurs at the leak, and this seals the membrane at this point. As a result, leaks are ‘healed’ due to melting of the porous, non-ion-conducting material at the leak point.

The present invention relates to a ceramic ion-selective membrane assembly and utilises a different phenomenon for self-healing: Due to the chemical and/or electrical gradients over the membrane during operation the fast ions feel a driving force. The transport of metal cations present in the membrane will however also be influenced by this driving force. In the bulk of an intact dense membrane, the transport of metal cations will usually be very slow. However, when a defect occurs, metal cation transport can be enhanced by orders of magnitude towards and into the defect, driven by the chemical or electrical potential difference between the two sides of the membrane. In the following the term “ceramic ion-selective membrane” is used for the “dense functional layer” of the assembly, and vice versa.

The present invention provides a self-healing ceramic ion-selective membrane assembly comprising: a ceramic ion-selective membrane and at least one additive layer comprising an ionic ceramic material which is porous or ion-selective, wherein the at least one additive layer having a metal cation diffusivity higher than the metal cation diffusivity of the ceramic ion-selective membrane.

Further, the present invention provides a method of forming a self-generating and self-healing ceramic ion-selective membrane assembly, comprising the steps of providing a first layer made of an oxide material, contacting the first layer with a second layer made of an oxide material different than the first layer, reacting the first and second layers during heating to an operating temperature of the membrane assembly to form an ion-selective membrane having a metal cation diffusivity lower than the metal cation diffusivities of the first and second layer.

In the first aspect of the invention, the self-healing ceramic ion-selective membrane assembly comprises a ceramic ion-selective membrane which is a dense functional layer having a lower metal cation diffusivity (rate of diffusion of metal cations) than the metal cation diffusivity of the at least one additive layer.

During operation of the membrane, at least one additive layer is capable of healing a defect that occurs through the dense ion-selective layer.

The ceramic ion-selective membrane may comprise a first oxide material, preferably having a fluorite-related structure, such as ZrO₂ or CeO₂ doped with rare earth metal oxides as acceptors. Fluorite-related structures comprise also pyrochlore-type and rare-earth sesquioxide type structures. The material of the at least one additive layer may comprise a second oxide material, preferably having a perovskite-related structure containing as one main component multivalent transition metals from groups 5-13 of the periodic table, such as LaCoO₃ or La₂NiO₄. These oxides are chosen because oxides with fluorite-related structures typically have relatively slow cation diffusivities, whereas oxides with perovskite-related structures containing multivalent cations typically have relatively faster cation diffusivities.

Alternatively, the ceramic ion-selective membrane may comprise a first oxide material, having a perovskite-related structure with main metal components from groups 1-5 or 13-15 of the periodic system of elements, i.e. without multivalent metal cations, for example BaZrO₃ doped with rare earth metal oxides as acceptors. In this case, the oxide material of the at least one additive layer must be selected from oxide materials having faster cation diffusivity than the selected perovskite structure of the ion-selective membrane. This additive layer may preferably be selected from perovskites having multivalent cations from groups 5-13 of the periodic system of elements, such as LaCoO₃ or La₂NiO₄, or oxides with different crystal structures with relatively fast cation diffusion, indicated by relatively low melting points, like Bi₂O₃.

Diffusion coefficients have high activation energies, are therefore exponentially dependent on temperature, and vary by many orders of magnitude between different crystal structures, compositions, pathways, diffusion mechanisms, types of defects, and types of diffusing ions. It is thus possible to identify many types of oxide classes and specific oxides with widely varying diffusivities. Typically, the fast ions utilised for transport in the ion-selective membranes, like oxide ions, have diffusivities of 10-10⁴ cm²/s at operating temperatures, e.g. 800° C. The slow cations of the same ion-selective membranes, such as fluorites like ZrO₂ and perovskites like BaZrO₃, on the other hand, have diffusivities of down to 10⁻²⁰ cm²/s at the same temperature, holding the oxide as such stationary during use. Faster cations, for instance in many mixed valency transition-metal based perovskite-related oxides like La₂NiO₄, are many orders of magnitude faster, typically 10⁻¹² cm²/s. Furthermore, fast diffusion paths in the surfaces of opening holes and cracks are even faster, typically corresponding to 10⁻⁸ cm²/s, It is this we utilise here; the ratio between this diffusivity and that of the slow cations in bulk can reach as much as 12 orders of magnitude. In reality, there may be short-circuit paths like grain boundaries and dislocations also in the functional ion-selective, increasing its effective cation diffusivities by some orders of magnitude, so that the ratio is reduced. We consider that the required ratio for self-healing is 6 orders of magnitude. A membrane with lifetime limited to 10 years by cation diffusion, will then have a healing diffusion process taking of the order of 1 hour. Preferably, we would have a ratio of 7 to 8 orders of magnitude to have more headroom and faster healing and a more stable membrane.

In a first embodiment of the invention, the ceramic ion-selective membrane assembly comprises a ceramic ion-selective membrane and one additive layer. A chemical or electrical gradient across the ceramic ion-selective membrane acts not only as a driving force for the fast ions, e.g. oxide ions or protons, and any mobile electrons, but also as a driving force for metal cations to move, and in particular the faster metal cations from the additive layer to diffuse toward the other side when a defect occurs. These metal cations from the additive layer are however practically able to diffuse only when there is a defect present, whereby they diffuse toward and into the opening of the defect, eventually plugging and sealing the defect.

When there is net diffusion of metal cations like this, there is also net transport of anions through the additive layer or ceramic ion-selective membrane or in the gas phase of the defect. In effect, it is the compound of anions and metal cations that diffuses and plugs the defect. Typically, the anions are oxide ions and the compound is a metal oxide.

In other words, the ceramic ion-selective membrane assembly is healed at defects (such as holes or cracks through the dense functional layer) by metal cations (and anions) diffusing from the additive layer. The metal cations react and form a plug of ceramic material to fill and seal the defect. This plug of material may be an inert non-functional filler material or a functional material. By the term “functional” it is meant ion-selective properties. In any case, the plug must be non-porous and gas-tight and blocks gas leakage through the membrane, i.e. the gas tight property of the ion-selective membrane can be restored.

The process described may be called chemical creep closure. In this embodiment, the additive material itself creeps into the defect and forms a plug of material, which seals the defect. The creep in this case takes place by chemical diffusion of the metal cations of the additive layer down their chemical potential gradient. This is established for instance by the presence of a difference in the partial pressure of the anion component (such as oxygen) on the two sides of the membrane, through the formation equilibrium of the compound. Fuel cells, electrolyzers, and oxygen gas separation membranes are applications which operate with large differences in oxygen partial pressure.

For the purpose of the above-described healing mechanism, the additive layer must be placed at the side of the membrane with the lower activity of the anion component (reducing, low oxygen partial pressure side in the case of oxides).

Once the defect has been sealed, the diffusion of ions from the additive layer will slow down or stop until a further defect forms through the dense functional layer. In other words, due to the chemical gradient across the membrane (due to the different environments on either side of the membrane), chemical creep of one phase may occur towards and into a hole/defect/crack in the dense functional layer towards the atmosphere on the other side of the membrane which results in a plug of material forming in the hole which seals the hole.

While the membrane is intact, or in areas where it is intact, or where defects have been sealed, there is no fast pathway for metal cation diffusion, and the additive layer stays on the side where it is added, until a defect opens, and ion transport starts and proceeds until the defect is closed.

The self-healing ceramic ion-selective membrane may be used in high-temperature electrochemical devices which have ceramic electrolyte membranes, such as solid oxide fuel cells (SOFC), solid oxide electrolyser cells (SOEC), proton ceramic fuel cells (PCFC) and proton ceramic electrolyser cells (PCEC). The membrane may alternatively be a mixed ion-electron conducting dense ceramic material, which may be used as oxygen transport membranes (OTM) or hydrogen transport membranes (HTM) for gas separation processes or for catalytic processes.

Preferably, the rate of diffusion of the metal cations from the additive layer to and into the defect is fast enough to seal the defect within a few days during normal operation, which is short compared to the lifetime of several years of the membrane. When defects are continuously self-healing in this manner as they appear, the membrane will remain overall intact and operative.

A temporary heating above the normal operating temperature of the self-healing ceramic ion-selective membrane assembly may accelerate the repair.

In an example system, the dense ion-selective membrane comprises an oxide, which exhibits relatively slow metal cation diffusion. Examples of oxides comprise Gd-doped CeO₂ (GDC), Y-stabilised ZrO₂ (YSZ), and La₆₋ₓWO_{12-y}, where x and y are deviations smaller than 1.0 from the integer stoichiometric coefficients. It may operate in a gas separation membrane configuration, or as an electrolyte in an electrochemical cell, and in both cases stands in a gradient of oxygen partial pressure. An additive layer comprising an oxide which exhibits faster metal cation diffusion than that of the dense ion-selective membrane is added on the low oxygen partial pressure side. The two materials of the membrane and the additive layers are selected so as to be stable and not react with each other and remain as two separate layers during normal operation of the membrane. However, the metal cations in the additive layer will diffuse fast along surfaces of the dense functional membrane, and hence, once a defect like a crack or pinhole opens, the additive oxide will start to creep towards the high oxygen partial pressure exposed through the defect and close the defect in the functional layer.

In an example system, the dense functional layer comprises the oxide La₆₋ₓWO_{12-y}, where x and y are deviations smaller than 1.0 from the integer stoichiometric coefficients, which exhibits relatively slow metal cation diffusion, and the additive layer comprises the oxide La₂NiO₄, which exhibits faster metal cation diffusion.

In a second embodiment, the ceramic ion-selective membrane assembly comprises a ceramic ion-selective membrane and one additive layer. The additional layer or components of the additional layer reacts with the ion selective membrane material itself, but only under the conditions at the opposite side of the membrane, meaning that it is only activated when a defect occurs and exposes the conditions of the opposite side of the membrane to the additive layer.

As example systems, the additional layer comprises an oxide with multivalent cations in a relatively low oxidation state, which may oxidise and then react with a functional membrane material upon exposure to a higher pressure of oxygen through the opening of a defect. The cations then diffuse towards and into the opening and close it by reacting with the membrane oxide material and expanding it by means of the additional component.

As an example system, an oxygen separation membrane of La₂NiO₄ has an additive layer of CoO on the low oxygen pressure (permeate) side. Under these conditions, cobalt is divalent (Co²⁺) and does not dissolve in the membrane material. However, if a hole forms, the higher oxygen pressure leaking in from the high oxygen pressure side oxidises cobalt to Co³⁺, which readily dissolves in the membrane, forming Ruddlesden-Popper phases, e.g. La₃(Ni,Co)₂O₇ with larger volume, expanding the membrane and plugging the hole.

In a third embodiment, the self-healing ceramic ion-selective membrane assembly comprises a ceramic ion-selective membrane and two additive layers, wherein a second additive layer is provided on the ion-selective membrane at the opposite side of the aforementioned first additive layer. The material of the second additive layer may be selected so that when metal cations from the second additive layer meet or interact with metal cations of the first additive layer, they react to form a new material, and thereby seals the defect. The reaction establishes a gradient in chemical potential of the metal cations driving them in the direction of each other, enabled by the fast transport towards and, into, and through the opening of a defect, independent of gradients in the atmospheres on the two sides. This may be known as reaction growth repair (RGR). In other words, two chemical compounds form a third compound, which serves as a gastight seal in or on the defect in the dense functional layer.

The direction of diffusion of metal cations from the second additive layer is opposite to the direction of diffusion of metal cations in the first additive layer. For example, metal cations from the first additive layer may diffuse towards the compound on the side of the second additive layer and metal cations from the second additive layer may diffuse towards the compound on the side of the first additive layer. This implies that metal cations from the first additive layer and metal cations from the second additive layer meet in the defect in the dense functional layer where they may react to form a third material, and thereby form a plug. The plug will form in the middle of the defect or towards one of the sides depending on the rate of diffusion of the metal cations from the two additive layers.

The material formed when the metal cations from the first and second additive layers meet may be a dense inert material. Alternatively, the material may be a dense functional material for fast transport of ions there across. The material formed may be the same material as the material of the dense functional layer. This means that the functional area of the dense functional layer will not decrease over time as the membrane develops defects that self-heal.

As a first example, the first additive layer comprises MO, the second additive layer comprises La₆₋ₓWO_{12-y}, where x and y are deviations smaller than 1.0 from the integer stoichiometric coefficients, and the dense functional layer comprises a gas separation membrane material of LaNiO₃ or La₂NiO₄. As a second example, the first additive layer may comprise Fe₂O₃, the second additive layer Mn₂O₃ and the dense functional layer comprises a membrane material of CaTi_{0.85-x}Fe_{0.15}MnₓO₃ where x is smaller than or equal to 0.4.

In the two following examples the dense functional layer comprises a dual phase ceramic-ceramic composite membrane material which may be used as OTM. In one system, the first additive layer may comprise Fe₂O₃, the second additive layer Mn₂O₃ and the dense functional layer comprises a composite membrane material of GDC (conducts oxide ions) and MnFe₂O₄ (conducts electrons). In another system the first additive layer may comprise Fe₂O₃, the second additive layer may comprise NiO, and the electronically conducting phase in the dense functional layer may comprise NiFe₂O₄.

In a fourth embodiment, the self-healing ceramic ion-selective membrane assembly may be a self-generating ion-selective membrane assembly. This means that two additive layers made of different materials form the dense ceramic ion-selective membrane by a reaction between the two additive layers when the two additive layers are in contact with each other.

The second aspect of the present invention relates to a method of self-generating a self-healing ion-selective ceramic membrane assembly. The method comprises: providing a first layer made of an oxide material and contacting the first layer with a second layer, wherein the materials of the first and second additive layers are selected so that when they are in contact they react to form a dense functional layer for transport of ions across the membrane, the ion selective ceramic membrane hence comprising the dense functional layer between the first and second additive layers. The reaction takes place during heating to operating temperature of the assembly. To accelerate the formation of the ion-selective membrane the self-generating ceramic ion-selective membrane assembly may temporarily be heated above the operating temperature. The dense functional layer (i.e. the ion-selective membrane) will typically become thin, because the process of formation is considerably retarded once the direct access of remaining holes is closed. If there is a subsequent defect in the membrane formed, it will immediately start repairing by formation of new membrane material. This means that the self-generating ion-selective ceramic membrane assembly also can be self-healing.

The oxide materials of the first and second layer is selected from ionic ceramic oxides that will form a ion-selective membrane having a lower metal cation diffusivity than the ionic ceramic oxide materials of the first and the second layer

The additive layers of the self-healing ceramic ion-selective membrane according to the invention are porous or ion-selective. This means that additive layers can cover the surface of the dense functional layer whilst still permitting the atmosphere around the self-healing ceramic ion-selective membrane assembly to reach the surface of the dense functional layer. This is so that the dense functional layer can perform its function of selectively transporting ions through the dense functional layer.

The additive layers may have a second function in addition to providing the ions, which seal the defects. For example, the additive layers may provide a support layer for providing structural support for the dense functional layer. This can be useful when the dense functional layer is very thin, and thus, requires structural support. Additionally or alternatively, the self-healing ceramic ion-selective membrane assembly (i.e. the additive layer(s) and the dense functional layer) may be supported on a supporting layer, which is preferably porous.

When the self-healing ceramic ion-selective membrane assembly is used in a fuel cell for example, an additive layer may also function as an electrode. When there are two additive layers, one layer may act as a cathode and the other layer may act as an anode. When the additive layer(s) function as an electrode, it is preferable for the layer to still function as an electrode after ions have diffused to heal the dense functional layer.

In another example system, the first additive layer comprises TiNb₂O₇, the second functional layer comprises Ca-doped LaMnO₃ and the dense functional layer comprises the proton conducting electrolyte Ca-doped LaNbO₄. In this system, TiNb₂O₇ and Ca-doped LaMnO₃ can react to form Ca-doped LaNbO₄. This means that when, in use, there is a chemical gradient and a defect in the dense functional layer, cations from the additive layers can diffuse to the defect and react to seal or fill the defect with functional material for selective ion transport.

Moreover, layers of TiNb₂O₇ annealed in contact with Ca-doped LaMnO₃ react to form a new film (layer) of Ca-doped LaNbO₄.

In these cases, the Ca-doped LaNbO₄ is an ion-conducting solid-state electrolyte. The additional layers of TiNb₂O₇ and Ca-doped LaMnO₃ are electronically conducting and may act as electrodes on the reducing and oxidising sides of for instance a fuel cell. Moreover, the reaction to form new Ca-doped LaNbO₄ during repair or self-assembly leaves Nb-doped TiO₂ and La-deficient Ca-doped LaMnO₃, which are themselves electronically conducting, ensuring continued functional operation of the device.

Certain preferred embodiments of the present invention will now be described by way of example only with reference to the accompanying drawings.

### FIGURES

FIGS. 1 a-d show the chemical creep repair of a self-healing ion-selective membrane assembly.

FIGS. 2 a-d show the reactive creep repair of a self-healing ion-selective membrane assembly.

FIGS. 3 a-e show the reaction growth repair of a self-healing ion-selective membrane assembly.

FIGS. 4 a and b show the self-generating and self-healing ion-selective membrane assembly.

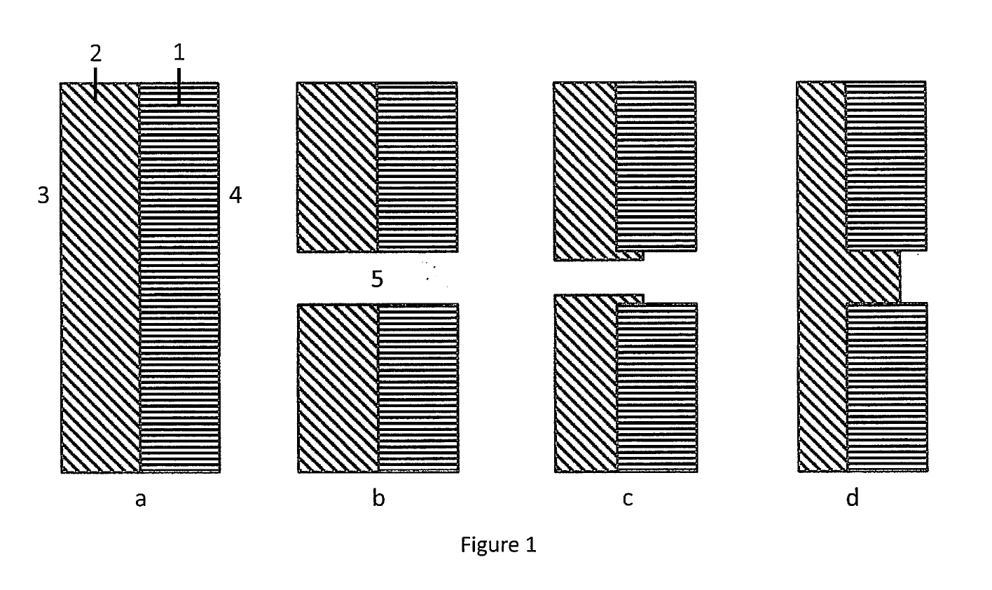

An example on how a self-healing ceramic ion-selective membrane according to the present invention will repair itself (self-heal) when a defect occurs during use is schematically shown in FIGS. 1a to 1d. FIG. 1a shows the intact membrane assembly, i.e. without any defects. The membrane assembly consists of a dense functional ion-selective layer 1 and a porous or ion-permeable additive layer 2. The dense functional ion-selective layer 1 is gastight (when there are no defects) and only permits transport of certain ions through the gastight layer.

In FIG. 1a, on the additive layer side 3, the anion component activity is lower than the anion component activity on the ion-selective layer side 4. For example in an operating fuel cell, there will be a chemical gradient across the membrane assembly such as a lower oxygen partial pressure on the additive layer side 3 compared with the higher oxygen partial pressure on the ion-selective layer side 4. FIG. 1b shows the situation where a defect has resulted in an opening 5 through the membrane assembly. Because of the difference of the anion component activity on both sides of the membrane assembly, the metal ions of the additive layer will immediately start to diffuse toward and into the opening and thereby begin repairing the defect; see FIG. 1c. The additive layer compound creeps towards the high anion component activity side. FIG. 1d shows the completely repaired membrane assembly, where the opening is plugged with the same material as of the additive layer 2.

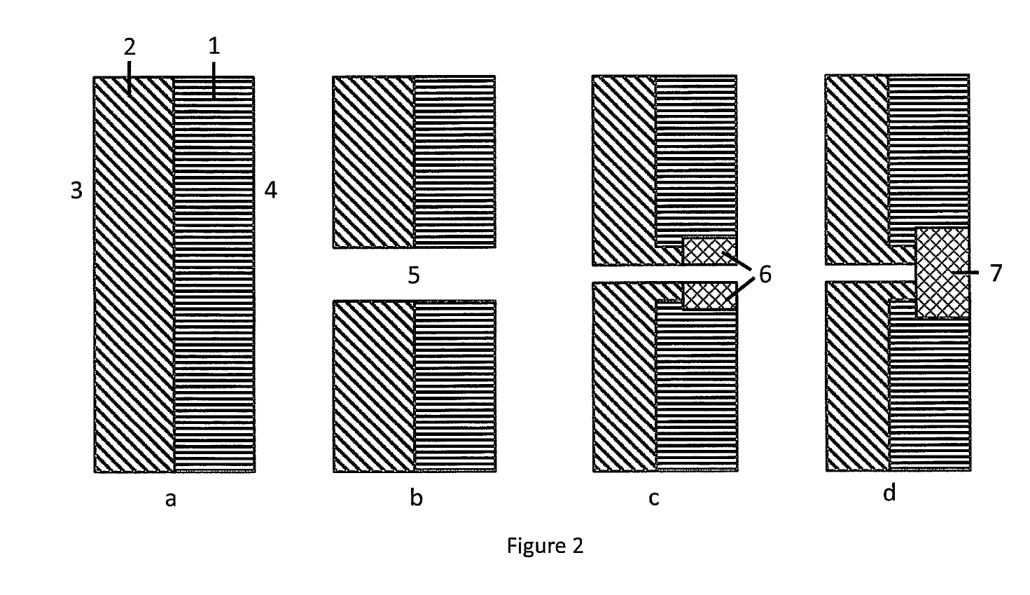

FIGS. 2a-2d schematically show another self-healing process of a self-healing ceramic ion-selective membrane according to the present invention. FIG. 2a shows the intact membrane assembly consisting of a dense functional ion-selective layer 1 and a porous or ion-permeable additive layer 2. FIG. 2b shows the situation where a defect has resulted in an opening 5 through the membrane assembly. FIG. 2c shows the beginning of the repair of the opening 5. In this case, the additive layer compound diffuses towards the high anion component activity side and in the presence of this higher anion component activity reacts with the functional material of the ion selective layer and starts forming a third material 6. The materials of the dense functional ion-selective layer 1 and the porous or ion-permeable additive layer 2 are selected so that they will chemically react when a defect resulting in an opening through the membrane occurs. FIG. 2d shows the completely repaired membrane assembly, having a plug 7 closing the opening with the newly formed third material.

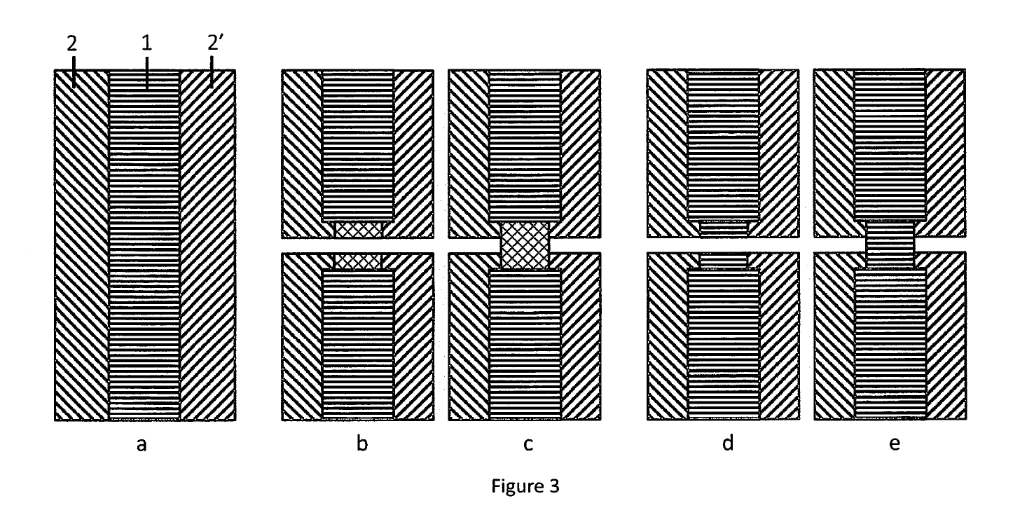

FIG. 3 schematically shows the self-healing process of another embodiment of the self-healing ceramic membrane assembly of the present invention. FIG. 3a shows an intact membrane assembly consisting of a dense functional ion-selective layer 1 and two porous or ion-permeable additive layers, 2 and 2′, arranged on each side of the dense functional ion-selective layer 1. Depending on the materials selected for the two additive layers, two routes are possible; 3b-3c or 3d-3e. FIGS. 3b and 3d show the situation where a defect has resulted in an opening through the membrane assembly and the self-healing has started. Depending on the materials selected for the two porous or ion-permeable additive layers 2 and 2′, either a non-functional product phase or a functional ion-selective product phase is formed. FIGS. 3c and 3e show completely repaired membrane assemblies, wherein the defect in FIG. 3c is plugged by a non-functional product phase and in FIG. 3e, the defect is plugged by a functional ion-selective product phase.

As a first example of formation of a functional product phase, the additive layers 2 and 2′ may be made of TiNb₂O₇ and Ca-doped or Sr-doped LaMnO₃. Ions from these materials can react to form the proton conducting electrolyte Ca-doped LaNbO₄, which seals the defects (Route 3d-3e) As another example, the additive layers 2 and 2′ may be made of NiO and La₆₋ₓWO_{12-y}, where x and y are deviations smaller than 1.0 from the integer stoichiometric coefficients, which react to form a gas separation membrane material of LaNiO₃ or La₂NiO₄ (Route 3d-3e).

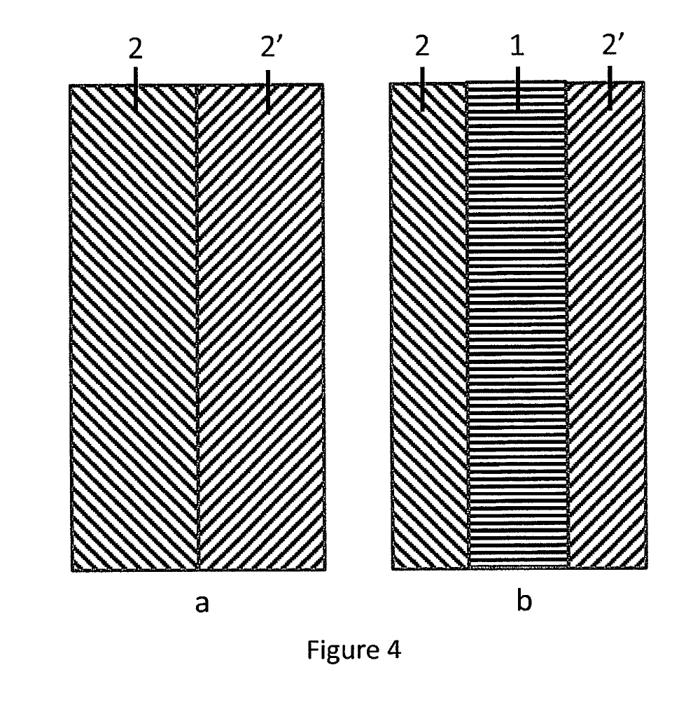

FIG. 4 schematically shows the process of preparing a self-generating ceramic membrane assembly according to the invention. FIG. 4a shows the start where two porous or ion-permeable additive layers, 2 and 2′, are contacting each other. The materials of the two additive layers 2 and 2′ are selected so that they may react and form a dense functional ceramic ion-selective membrane during heating to an operating temperature of the membrane assembly to form an ion-selective membrane. FIG. 4b shows the completed membrane assembly having a dense functional ion-selective layer 1 between the two porous or ion-permeable additive layers 2 and 2′. This membrane assembly will also be self-healing, because when a defect occurs through the dense functional membrane the two porous or ion-permeable additive layers 2 and 2′ will react and the defect will be repaired.

1. A self-healing ceramic ion-selective membrane assembly, comprising:
a ceramic ion-selective membrane, and
at least one additive layer, wherein said at least one additive layer comprises an ionic ceramic material which is porous or ion-selective,
wherein said at least one additive layer has a metal cation diffusivity higher than the metal cation diffusivity of the ceramic ion-selective membrane.

2. The self-healing ceramic ion-selective membrane assembly of claim 1, wherein the metal cation diffusivity of the at least one additive layer is at least 6 orders of magnitude higher than the metal cation diffusivity of the ceramic ion-selective membrane.

3. The self-healing ceramic ion-selective membrane assembly of claim 1, wherein the ceramic ion-selective membrane comprises a first oxide material and the at least one additive layer comprises a second oxide material.

4. The self-healing ceramic ion-selective membrane assembly of claim 3, wherein the first oxide material has a fluorite-related structure or a perovskite-related structure.

5. The self-healing ceramic ion-selective membrane assembly of claim 1, wherein during operation of the membrane assembly, a chemical and/or electrical gradient across the membrane causes the metal cations of the at least one additive layer to diffuse towards and into any occurring defect(s) through the membrane and form a plug.

6. The self-healing ceramic ion-selective membrane assembly of claim 1, wherein the ceramic ion-selective membrane comprises La6-xWO12-y, and the at least one additive layer comprises La2NiO4.

7. The self-healing ceramic ion-selective membrane assembly of claim 1, wherein during operation of the membrane assembly, a chemical and/or electrical gradient across the membrane causes metal cations of the at least one additive layer to react with the ceramic ion-selective membrane in the presence of the atmosphere on an opposite side and a third material is formed in the defect of the ceramic ion-selective membrane.

8. The self-healing ceramic ion-selective membrane assembly of claim 7, wherein the ceramic ion-selective membrane comprises La2NiO4 and the at least one additive layer comprises CoO.

9. The self-healing ceramic ion-selective membrane assembly of claim 1, further
comprising two additive layers made of different oxide materials, the two additive layers are arranged on opposite sides of the ceramic ion-selective membrane.

10. The self-healing ceramic ion-selective membrane assembly of claim 9, wherein during operation, when a defect through the ceramic ion-selective membrane occurs, a gradient in chemical potential will be established between the two oxide materials, and the two oxide materials react and form a third oxide material in the defect.

11. The self-healing ceramic ion-selective membrane assembly of claim 9,
wherein the oxide material of one of the two additive layers is selected from the group of La6-xWO12-y, Nb-doped TiO2, and TiNb2O7 and the oxide material of the other additive layer is selected from the group of NiO and Ca- or Sr-doped LaMnO3.

12. The self-healing ceramic ion-selective membrane assembly of claim 1, comprising two additive layers made of different oxide materials, wherein the ceramic ion-selective membrane is formed by a reaction between the two additive layers when the two additive layers are in contact with each other.

13. The self-healing ceramic ion-selective membrane assembly of claim 12, wherein one of the two additive layers comprises an oxide material selected from the group of La6-xWO12-y and Nb-doped TiO2, TiNb2O7, and the other additive layer comprises an oxide material selected from the group of NiO and Ca- or Sr-doped LaMnO3.

14. A method of forming a self-generating and self-healing ceramic ion-selective membrane assembly, comprising the steps of:
providing a first layer made of an oxide material,
contacting the first layer with a second layer made of an oxide material different than the first layer,
reacting the first and second layers during heating to an operating temperature of the membrane assembly to form an ion-selective membrane having a metal cation diffusivity lower than the metal cation diffusivities of the first and second layer.

15. The method of claim 14, wherein the membrane assembly is heated above the operating temperature to accelerate the formation of the ion selective membrane.

16. A method of using the self-healing ceramic ion-selective membrane assembly of claim 1, in high-temperature electrochemical devices which have ceramic electrolyte membranes, selected from solid oxide fuel cells (SOFC), solid oxide electrolyser cells (SOEC), proton ceramic fuel cells (PCFC) and proton ceramic electrolyser cells (PCEC).

17. A method of using the self-healing ceramic ion-selective membrane assembly of claim 1, in applications which use mixed ionic-electronic conduction to achieve selective gas permeation, selected from oxygen transport membranes (OTM) or hydrogen transport membranes (HTM) for gas separation processes.

18. A method of using the self-healing ceramic ion-selective membrane assembly of claim 1, comprising initiating catalytic reactions in catalytic membrane reactors.
